(19) United States
(12) Patent Application Publication
(10) Pub. No.: US 2003/0094513 A1
(43) Pub. Date: May 22, 2003

(54) Fuel-injection valve and a method for regulating the same

(76) Inventor: Heinz Luft, Hirschaid (DE)

Correspondence Address: KENYON & KENYON, ONE BROADWAY, NEW YORK, NY, 10004, US

(21) Appl. No.: 10/089,664

(22) PCT Filed: Jul. 18, 2001
(86) PCT No.: PCT/DE01/02699

(30) Foreign Application Priority Data
Aug. 2, 2000 (DE) 100 37 570.7

(51) Int. Cl. F02M 59/00

(52) U.S. Cl. 239/533.9; 239/533.2; 239/585.1; 239/585.4; 239/585.5

(57) ABSTRACT

A fuel injector (1) for fuel injection systems of internal combustion engines, in particular for direct injection of fuel into the combustion chamber of an engine, includes an actuator (10), a valve needle (3) which is mechanically linked to the actuator (10) and is acted upon by a restoring spring (23) in a closing direction to actuate a valve closing body (4), which together with a valve seat face (6) forms a sealing seat, and it has a sleeve (24) which pre-stresses the restoring spring (23). The sleeve (24) is plastically deformable so that the cross section of a flow-through channel (46) of the sleeve (24) is variable by mechanical action.

### BACKGROUND INFORMATION

The present invention is based on a fuel injector according to the preamble of claim 1 and a method of adjusting a fuel injector according to the preamble of claim 11.

German Patent Application 40 23 828 A1 describes a fuel injector and a method of adjusting a fuel injector. To adjust the amount of fuel to be delivered during the opening and closing operation of the electromagnetically operable fuel injector, a magnetically conductive material, e.g., in the form of a powder which alters the magnetic properties of the internal pole is introduced into a blind hole, and thus the magnetic force is varied until the actual measured flow rate of the medium corresponds to the predetermined setpoint flow rate.

Similarly, German Patent Application 40 23 826 A1 describes the insertion of an equalizing bolt into a blind hole of an internal pole having a recess on its periphery to the extent that the measured actual amount corresponds to the predetermined setpoint amount, and thus varying the magnetic force until this is achieved.

German Patent Application 195 16 513 A1 describes a method of adjusting the dynamic flow rate of a fuel injector. In this case, an adjusting element situated close to the magnetic coil outside the flow path of the medium is adjusted. In doing so, the magnetic flux in the magnetic circuit, and thus the magnetic force, changes, so it is possible to influence and adjust the flow rate. Adjustment can be performed with either wet or dry fuel injectors.

German Patent Application 42 11 723 A1 describes a fuel injector and a method of adjusting the dynamic flow rate of a fuel injector, in which an adjusting sleeve having a longitudinal slot is pressed into a longitudinal bore in a connection up to a predetermined depth, the dynamic actual flow rate of the injector is measured and compared with a setpoint flow rate and the pressed-in adjusting sleeve which is under a tension acting radially is pushed forward until the measured actual flow rate matches the predetermined setpoint flow rate.

In German Patent Application 44 31 128 A1, to adjust the dynamic flow rate of a fuel injector, the valve housing undergoes deformation due to the action of a deformation tool on the outer perimeter of the valve housing. The size of the residual air gap between the core and the armature, and thus the magnetic force, is varied in this way, thereby making it possible to influence and adjust the flow rate.

One disadvantage of the group of methods which influence the magnetic flux in the magnetic circuit is in particular the high expense with regard to production costs, because the required static flow tolerances must be guaranteed, although this is difficult to implement. In particular, measurements of magnetic fields are complicated to perform and require a test field.

One disadvantage of the group of mechanical adjustment methods is in particular the high degree of inaccuracy to which these methods are subject. Furthermore, the opening and closing times of a fuel injector may be shortened only at the expense of the electric power, so the electric load on the components and on the controllers is increased.

In particular, the method known from German Patent Application 44 31 128 A1, where the residual air gap between the core and the armature is varied by deformation of the valve housing, permits only a very inaccurate correction of the flow rate because shear stresses in the nozzle body may have a negative effect on the direction and magnitude of the deforming force. Therefore, a high manufacturing precision is necessary for all parts.

### ADVANTAGES OF THE INVENTION

The fuel injector according to the present invention having the characterizing features of claim 1 and the method according to the present invention for adjusting a fuel injector having the features of claim 11 have the advantage over the related art that the adjustment sleeve is capable of plastic deformation, and in this way the cross section of a flow channel provided in the sleeve may be varied easily by mechanical action using a stamping tool.

Advantageous refinements of the fuel injector characterized in claim 1 and the method characterized in claim 11 for adjusting a fuel injector are possible through the measures characterized in the subclaims.

It is advantageous in particular that an annular insert made of soft metal is inserted into the intake end of the sleeve and may be deformed without affecting the stability of the sleeve.

The design of a throttle zone in the flow channel of the sleeve having a peripheral collar projecting into the flow channel is advantageous inasmuch as this specific design of the throttle zone supports the desired deformation of the inlet end of the sleeve.

It is especially advantageous to provide an external thread on the sleeve and an internal thread in the central recess in the fuel injector, because the sleeve is thereby stable in its position in the central recess in the fuel injector and is prevented from slipping, while it is easily brought into a different position using a corresponding adjusting tool due to the thread.

Also advantageous is the design of the recess in the sleeve on the inlet side, e.g., in the form of a hexagon socket which is designed so that an adjusting tool which is mechanically linked to the sleeve does not act on the annular soft metal insert.

It is also especially advantageous that the restoring spring is supported on an intermediate ring which is inserted between the sleeve and the restoring spring in the central recess in the fuel injector, because in this way it is possible to rotate the sleeve with an adjusting tool without the restoring spring rotating with it. This prevents metal shavings from being deposited on the restoring spring.

### BRIEF DESCRIPTION OF THE DRAWING

Embodiments of the present invention are illustrated in simplified form in the drawing and are explained in greater detail in the following description:

FIG. 1 shows a schematic diagram of a section through an embodiment of a fuel injector according to the related art.

FIG. 2A shows a detail of a schematic diagram of a section through a first embodiment of the fuel injector according to the present invention, approximately in area II in FIG. 1 before performing a first adjustment according to the method of the present invention.

FIG. 2B shows the sleeve shown in FIG. 2A after performing the adjustment according to the method of the present invention.

FIG. 2C shows a detail of the sleeve corresponding to a second embodiment.

FIG. 3A shows a detail of a schematic diagram of a section through a third embodiment of the fuel injector according to the present invention in area II in FIG. 1 before performing a first step of a second adjustment according to the method of the present invention.

FIG. 3B shows the sleeve in FIG. 3A after performing the first step of the method.

FIG. 4 shows a detail of a schematic diagram of a section through the embodiment according to FIG. 3 during the second step of the second adjustment according to the method of the present invention.

### DETAILED DESCRIPTION OF THE EMBODIMENTS

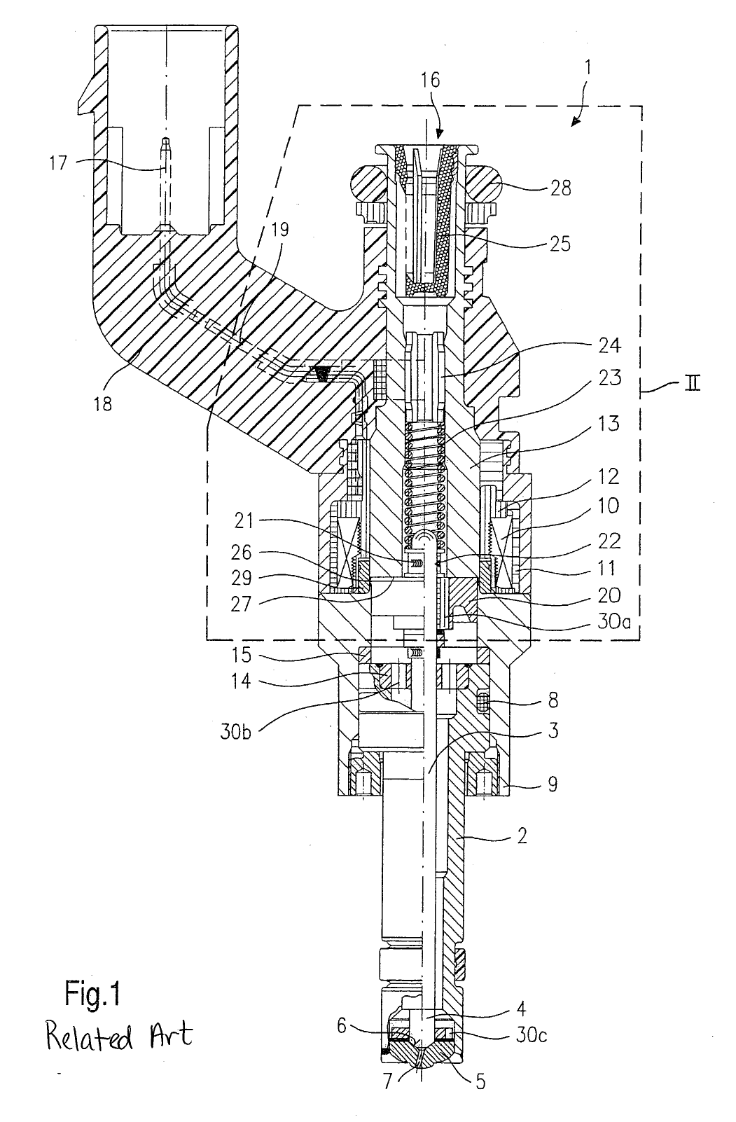

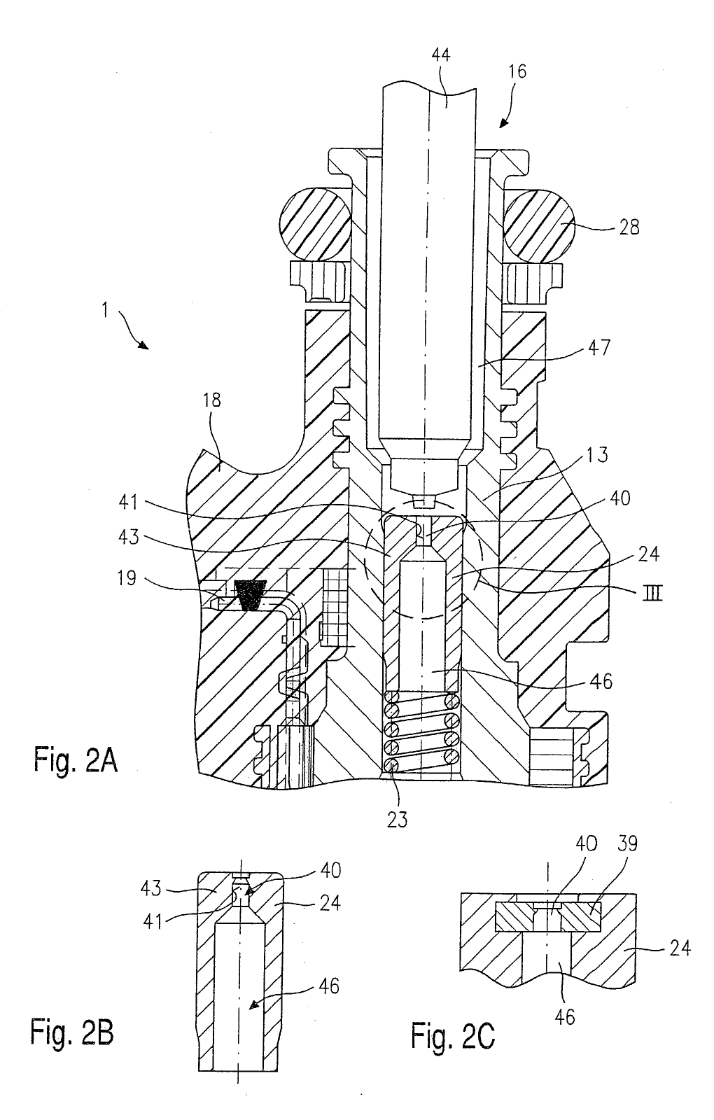

Before describing three embodiments of a fuel injector 1 according to the present invention in greater detail on the basis of FIGS. 2 through 4, a fuel injector 1 already known and having the same design as the embodiments except for the measures according to the present invention will first be explained briefly with regard to its essential components on the basis of FIG. 1.

Fuel injector 1 is designed in the form of a fuel injector for fuel injection systems of engines having spark ignition of a fuel-air mixture. Fuel injector 1 is suitable in particular for direct injection of fuel into a combustion chamber (not shown) of an internal combustion engine.

Fuel injector 1 has a nozzle body 2 in which a valve needle 3 is guided. Valve needle 3 is mechanically linked to a valve closing body 4 which cooperates with a valve seat face 6 situated on a valve seat body 5 to form a tight seat. In this embodiment, fuel injector 1 is an inwardly opening fuel injector 1 having an injection orifice 7. Nozzle body 2 is sealed by a seal 8 with respect to stationary pole 9 of a magnetic coil 10. Magnetic coil 10 is encapsulated in a coil housing 11 and is wound on a field spool 12 which is in contact with an internal pole 13 of magnetic coil 10. Internal pole 13 and stationary pole 9 are separated by a gap 26 and are supported on a connecting component 29. Magnetic coil 10 is energized by electric current supplied via a line 19 and an electric plug contact 17. Plug contact 17 is surrounded by a plastic sheathing 18 which may be integrally molded on internal pole 13.

Valve needle 3 is guided in a valve needle guide 14 designed in the form of a disk. A matching adjustment disk 15 is used to adjust the lift. On the other side of adjustment disk 15 there is an armature 20 which is in a friction-locked connection with valve needle 3 via a flange 21, the valve needle being connected to flange 21 by a weld 22. A restoring spring 23 sits on flange 21 and is pre-stressed by a sleeve 24 in the present design of fuel injector 1. Fuel channels 30a through 30c which carry the fuel supplied through a central fuel supply 16 and filtered through a filter element 25 to injection orifice 7 run in valve needle guide 14, armature 20 and on valve seat body 5. Fuel injector 1 is sealed with respect to a fuel line (not shown) by a seal 28.

In the resting state of fuel injector 1, armature 20 is acted upon by restoring spring 20 against its direction of lift so that valve closing body 4 is held sealingly against valve seat 6. When magnetic coil 10 is energized, it creates a magnetic field which moves armature 20 in the direction of lift against the elastic force of restoring spring 23, the lift being predetermined by a working gap 27 between internal pole 12 and armature 20 in the resting position. Armature 20 also entrains flange 21, which is welded to valve needle 3, in the direction of lift. Valve closing body 4, which is mechanically linked to valve needle 3, is lifted up from the valve seat face, and the fuel carried through fuel channels 30a through 30c is injected through injection orifice 7.

When the coil current is turned off, armature 20 drops back from internal pole 13 due to the pressure of restoring spring 21 after the magnetic field has declined sufficiently, so that flange 21, which is mechanically linked to valve needle 3, moves against the direction of lift. Valve needle 3 is thus moved in the same direction, so that valve closing body 4 is placed on valve seat face 6 and fuel injector 1 is closed.

In an excerpt of a sectional diagram, FIGS. 2A-C show approximately the detail of fuel injector 1 labeled as II in FIG. 1 before stamping and two embodiments of the detail labeled as III in FIG. 2A after stamping.

In an excerpt of a sectional diagram, FIG. 2A shows the detail labeled as II in FIG. 1 of fuel injector 1, filter element 25 which is present in central fuel supply 16 in FIG. 1 having been removed and instead stamping tool 44 being inserted into central recess 47 of fuel injector 1. In the present embodiment, sleeve 24 has a throttle zone 40 which has a peripheral collar 41 projecting into a flow channel 46 of sleeve 24.

If stamping tool 44, which is in central recess 47 of fuel injector 1, is pressed against inlet end 43 of sleeve 24 with a defined force, the sleeve is compressed slightly. Therefore, the cross section of flow channel 46 of sleeve 24 is reduced in the area of throttle zone 40 because the material of sleeve 24 may only be displaced into throttle zone 40 due to the manner in which sleeve 24 is installed in central recess 47 of fuel injector 1.

FIG. 2B shows a diagram of sleeve 24 in area III in FIG. 2A after stamping, in which case inlet end 43 of sleeve 24 has a slightly compressed and thus reduced cross section in the area of throttle zone 40. The flow rate of fuel flowing through fuel injector 1 per unit of time is thus reduced.

Since this procedure could be reversed only by replacing sleeve 24, it is necessary for fuel injector 1 to have a higher actual flow rate before adjusting the flow rate than the ideal flow rate to be achieved.

FIG. 2C shows a variant of sleeve 24 after the stamping operation, in this case with an annular insert 39, preferably made of soft metal, being inserted into inlet 43 of sleeve 24. This variant has the advantage that sleeve 24 need not be made entirely of a deformable soft metal, but instead may be made of a stable metal, so the stability of sleeve 24 with respect to deformation is maintained.

Throttle zone 40 is thus formed by annular insert 39 so that sleeve 24 is designed as a cylinder having a cylindrical flow channel 46.

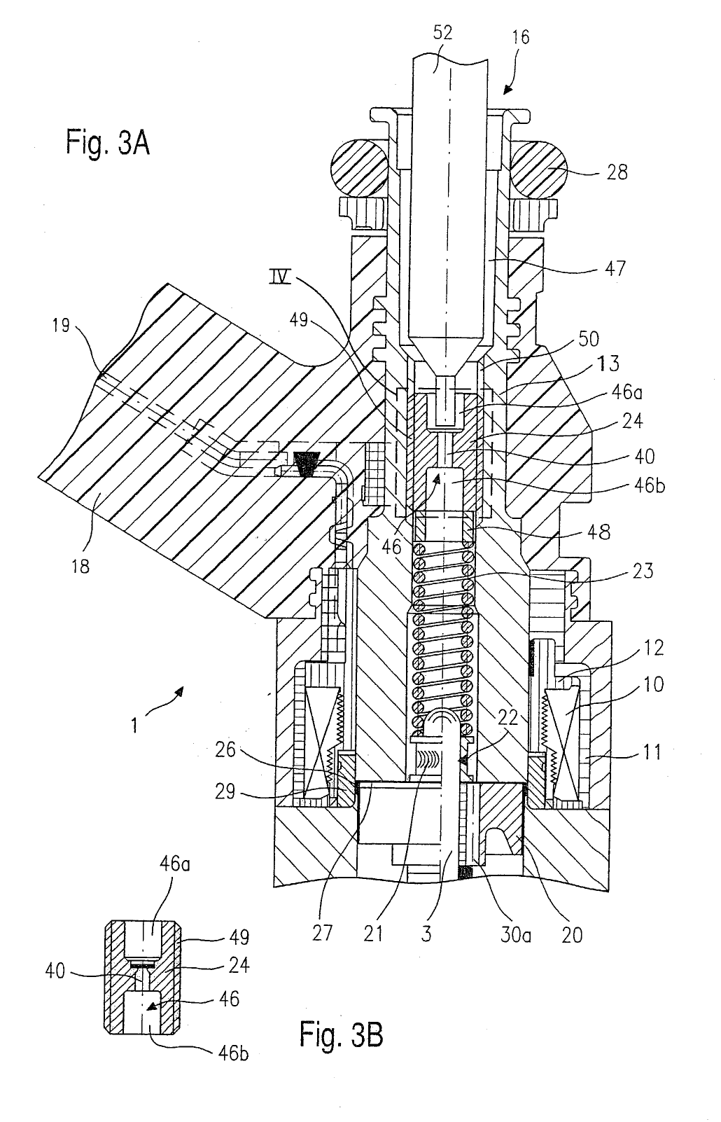

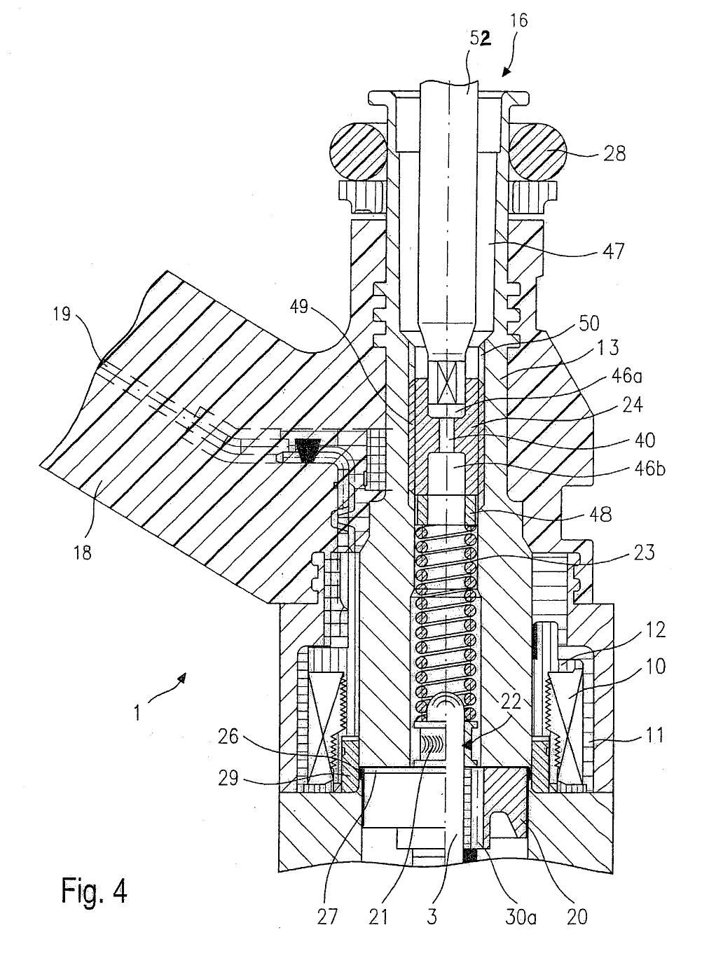

FIGS. 3A and 3B show another embodiment of fuel injector 1 according to the present invention, FIG. 3A sowing the first step of the method according to the present invention for adjusting a fuel injector 1, FIG. 3B showing the condition of sleeve 24 after the first method step, and FIG. 4 showing the second step of the method according to the present invention for adjusting a fuel injector 1.

In an excerpt of a sectional diagram, FIG. 3A shows the detail labeled as II in FIG. 1 of fuel injector 1 before stamping; FIG. 3B shows the detail labeled as IV in FIG. 3A after stamping.

In the present embodiment, sleeve 24 has a recess 46a on the inlet side and a recess 46b on the outlet side, throttle zone 40 being formed between them. Sleeve 24 is provided with an external thread 49 which works together with an internal thread 50 of central recess 47 of fuel injector 1. Sleeve 24 is screwed into central recess 47 of fuel injector 1 by thread 49 and thread 50. The inlet side of recess 46A of sleeve 24 is designed so that a corresponding adjusting tool 52 may be rotatably engaged with sleeve 24. The inlet side of recess 46A may have a hexagon socket section or a triangle socket section, for example.

Filter element 25 illustrated in FIG. 1 is again replaced by stamping tool 44 to perform the first step of the method according to the present invention for adjusting a fuel injector 1. Sleeve 24 is stamped by stamping tool 44 in the area of throttle zone 40 in the inlet side of recess 46A, slightly deforming the metal of sleeve 24 in the area of throttle zone 40. This reduces the static flow through fuel injector 1.

In an excerpt of a sectional diagram, FIG. 3B shows the detail labeled as IV in FIG. 3A with a reduction in cross section of flow-through channel 46 of sleeve 24 after the stamping operation.

In an excerpt of a sectional diagram, FIG. 4 shows the detail labeled as II in FIG. 1 of fuel injector 1, illustrating the second step of the method according to the present invention for adjusting fuel injector 1.

To adjust the dynamic flow through fuel injector 1, sleeve 24 is adjusted in its axial position in central recess 47 of fuel injector 1 using adjusting tool 52, which may be a hexagon socket wrench, a screwdriver or a similar tool, for example. The deeper sleeve 24 is screwed into central recess 47, the lower is the dynamic flow through fuel injector 1. This is due to the fact that restoring spring 23 is acted upon by sleeve 24 with a greater pre-stress, so that fuel injector 1 opens later and closes sooner.

To prevent restoring spring 23 from also turning as sleeve 24 rotates, an intermediate ring 48 is inserted between sleeve 24 and restoring spring 23, restoring spring 23 being supported on this intermediate ring. This measure prevents metal shavings from being detached from the wall of central recess 41, and thus clogging fuel channels 30a through 30c as well as injection orifice 7, due to the rotation of restoring spring 23 with it when sleeve 24 is twisted into central recess 47.

The present invention is not limited to the embodiments presented here and is also suitable for fuel injectors 1 having piezoelectric or magnetostrictive actuators, for example. In addition, the present invention may also be used to produce hydraulic and pneumatic throttles that are not adjustable.

What is claimed is:

1. A fuel injector (1) for fuel injection systems of internal combustion engines, in particular for direct injection of fuel into the combustion chamber of an engine, comprising an actuator (10), a valve needle (3) which is mechanically linked to the actuator (10) and is acted upon by a restoring spring (23) in a closing direction for actuation of a valve closing body (4), which, together with a valve seat face (6) forms a sealing seat, and having a sleeve (24) which pre-stresses the restoring spring (23),
wherein the sleeve (24) is plastically deformable such that the cross-section of a flow-through channel (46) of the sleeve (24) is variable in response to mechanical action.

2. The fuel injector according to claim 1, wherein an annular insert (39) which is plastically deformable is inserted into the inlet end (43) of the sleeve (24).

3. The fuel injector according to claim 2, wherein the annular insert (39) is made of soft metal.

4. The fuel injector according to one of claims 1 through 3, wherein the flow-through channel (46) of the sleeve (24) has a throttle zone (40).

5. The fuel injector according to claim 4, wherein the throttle zone (40) has a peripheral collar which is plastically deformable and projects into the flow-through channel (46).

6. The fuel injector according to one of claims 1 through 5, wherein the sleeve (24) has a thread (49) which cooperates with a thread (50) on a central recess (47) of the fuel injector (1).

7. The fuel injector according to claim 6, wherein the sleeve (24) is adjustable in its axial position by turning it in the central recess (47) of the fuel injector (1) using an adjusting tool (52).

8. The fuel injector according to claim 7, wherein the sleeve (24) has a recess (46a) on the inlet side into which the adjusting tool (52) is insertable so that it is in rotatably linked to the sleeve (24).

9. The fuel injector according to claim 8, wherein the restoring spring (23) is supported on an intermediate ring (48) which is situated between the sleeve (24) and the restoring spring (23) in the central recess (47) of the fuel injector (1).

10. The fuel injector according to claim 9, wherein the sleeve (24) is rotatable without causing the restoring spring (23) to move solidarity.

11. A method of adjusting a fuel injector (1) for fuel injection systems of internal combustion engines, in particular for direct injection of fuel into the combustion chamber of an engine, having an actuator (10), a valve needle (3) which is acted upon by a restoring spring (23) in a closing direction and is mechanically linked to the actuator (10), for actuating a valve closing body (4) which, together with a valve seat face (6), forms a sealing seat, and a sleeve (24) which is pre-stressed by the restoring spring (23), comprising the following method steps:
adjusting a static flow rate of the fuel by deforming the sleeve (24); and
adjusting a dynamic flow rate of the fuel by displacing the sleeve (4).

12. The method according to claim 11, having the following method steps:
measuring a static actual flow rate of the fuel injector
comparing the measured static actual flow rate with a static setpoint flow rate,
deforming the sleeve (24) by a stamping tool (44) until the static actual flow rate corresponds to the static setpoint flow rate.

13. The method according to claim 11, having the following method steps:
measuring a dynamic actual flow rate of the fuel injector (1),
comparing the measured dynamic actual flow rate with a dynamic setpoint flow rate,
displacing the sleeve (24) by rotation using an adjusting tool (52) until the dynamic actual flow rate corresponds to the dynamic setpoint flow rate.
